(19) United States
(12) Patent Application Publication
(10) Pub. No.: US 2017/0338536 A1
(43) Pub. Date: Nov. 23, 2017

(54) METAL-AIR BATTERY

(71) Applicant: HITACHI ZOSEN CORPORATION, Osaka (JP)

(72) Inventors: Keisuke FUGANE, Osaka (JP); Sousuke NISHIURA, Osaka (JP); Kazuya KAMEYAMA, Osaka (JP); Takehiro SHIMIZU, Osaka (JP); Masanobu AIZAWA, Osaka (JP)

(21) Appl. No.: 15/527,243

(22) PCT Filed: Oct. 15, 2015
(86) PCT No.: PCT/JP2015/079134

§ 371 Date: May 16, 2017

(30) Foreign Application Priority Data
Nov. 17, 2014 (JP) 2014-232466
Mar. 30, 2015 (JP) 2015-068952

(51) Int. Cl. H01M 12/08; H01M 2/16; H01M 4/86; H01M 4/90

(52) U.S. Cl. CPC H01M 12/08; H01M 4/90; H01M 2/16; H01M 4/86

(57) ABSTRACT

A metal-air battery (1) includes a tubular positive electrode (2), a negative electrode (3) opposing an inner side surface of the positive electrode (2), and an electrolyte layer (4) disposed between the negative electrode (3) and the positive electrode (2). The positive electrode (2) includes a porous positive electrode main body (21) that is made of conductive ceramic and serves as a tubular supporter, and a separator (41) that is a porous film made of ceramic having insulating properties is formed on the inner side surface of the positive electrode main body (21). Using the positive electrode main body (21) as a supporter makes it possible to easily increase the thickness of the positive electrode (2) and to thereby reduce the electrical resistance of the positive electrode (2) and improve the battery performance of the metal-air battery (1).

### TECHNICAL FIELD

The present invention relates to a metal-air battery.

### BACKGROUND ART

There are conventionally known metal-air batteries in which a separator is disposed between the negative electrode and the positive electrode. In Japanese Patent Application Laid-Open No. 2014-194897 (Document 1), for example, a separator disposed between the negative electrode and the positive electrode includes a separator body made of ceramic and serving as a porous supporter, and a porous film made of ceramic, formed on the surface of the separator body that faces the negative electrode, and having an average pore diameter smaller than that of the separator body. According to Document 1, penetration of deposited metal on the negative electrode through the separator can be prevented by setting the average pore diameter of the porous film larger than or equal to 0.01 micrometers (μm) and smaller than or equal to 2 μm and setting the thickness of the porous film greater than or equal to 50 μm and less than or equal to 200 μm.

In a lithium secondary battery disclosed in Japanese Patent Application Laid-Open No. 2006-310302 (Document 2), a separator includes a porous film made of a mixture of a ceramic material and a binder, and the binder consists of acrylic rubber having a three-dimensional crosslinked structure. Japanese Patent Application Laid-Open No. 2005-190833 (Document 3) discloses an electrode for secondary batteries that changes the composition of a perovskite type oxide so as to use a perovskite type oxide that functions effectively during oxygen reduction and a perovskite type oxide that functions effectively during oxygen generation. Japanese Patent Application Laid-Open No. 2004-265739 (Document 4) discloses a fuel battery cell that includes an oxygen electrode layer having a two-layer structure. The oxygen electrode layer includes a reaction layer that is made of fine particles of conductive ceramic having an average particle diameter of 2 μm or less, and a gas supply layer that is made of coarse particles of conductive ceramic having an average particle diameter of 10 to 100 μm.

In the metal-air batteries that use a separator as a supporter, for example, a positive electrode conductive layer and a positive electrode catalyst layer may be formed by depositing a predetermined ceramic-containing material on a surface of the supporter and firing the material. In such metal-air batteries, deposition and firing have to be repeated in order to increase the thickness of the positive electrode, and therefore, it takes a long time to manufacture the metal-air batteries. If there is a large difference in the coefficient of thermal expansion between the material for the separator and the material for the positive electrode conductive layer and the positive electrode catalyst layer, cracks or delamination may occur during firing. It is thus difficult in the metal-air batteries that use the separator as a supporter to increase the thickness of the positive electrode, and accordingly not possible to reduce the electrical resistance of the positive electrode and improve battery performance.

### SUMMARY OF INVENTION

The present invention is intended for a metal-air battery, and it is an object of the present invention to improve battery performance.

The metal-air battery according to the present invention includes a tubular positive electrode, a negative electrode opposing an inner or outer side surface of the positive electrode, and an electrolyte layer disposed between the negative electrode and the positive electrode. The positive electrode includes a porous positive electrode main body that is made of conductive ceramic and serves as a tubular supporter, and a porous film made of ceramic is formed on an inner or outer side surface of the positive electrode main body.

According to the present invention, using the positive electrode main body as a supporter makes it possible to easily increase the thickness of the positive electrode and to thereby reduce the electrical resistance of the positive electrode and improve battery performance.

In a preferred embodiment of the present invention, the porous film serves as a separator that is made of the ceramic having insulating properties and formed on a surface of the positive electrode main body on a side of the negative electrode. In this case, the positive electrode main body preferably has a thickness greater than a thickness of the separator. Moreover, another porous film that is made of ceramic and serves as a positive electrode catalyst layer may be formed on a surface of the positive electrode main body on a side opposite to the negative electrode. The porous film may be formed on the inner side surface of the positive electrode main body, and the another porous film may be formed on the outer side surface of the positive electrode main body.

In another preferred embodiment of the present invention, the porous film serves as a positive electrode catalyst layer that is formed on a surface of the positive electrode main body on a side opposite to the negative electrode.

In the metal-air battery including the positive electrode catalyst layer, the ceramic of the positive electrode catalyst layer may have a crystal structure that is identical to a crystal structure of the conductive ceramic of the positive electrode main body. Preferably, the ceramic of the positive electrode catalyst layer is superior in oxygen reduction reaction to the conductive ceramic of the positive electrode main body, and the conductive ceramic of the positive electrode main body is superior in oxygen generation reaction to the ceramic of the positive electrode catalyst layer.

In one aspect, the conductive ceramic of the positive electrode main body has an average particle diameter that is larger than or equal to 0.1 micrometers and smaller than or equal to 2 micrometers. In another aspect, the ceramic of the positive electrode catalyst layer has an average particle diameter that is larger than or equal to 1 micrometer and smaller than or equal to 10 micrometers. Preferably, the positive electrode catalyst layer has a thickness that is greater than or equal to 0.4 times a thickness of the positive electrode main body and less than or equal to 2.3 times the thickness of the positive electrode main body.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 illustrates a configuration of a metal-air battery;

FIG. 2 illustrates a procedure for producing a positive electrode;

FIG. 3 illustrates a configuration of a metal-air battery according to a comparative example;

FIG. 4 illustrates charge and discharge properties of the metal-air batteries;

FIG. 5 illustrates power densities of the metal-air batteries; and

FIG. 6 illustrates a relationship of the material for and particle diameter of each layer of the positive electrode, and charge and discharge performance.

### DESCRIPTION OF EMBODIMENTS

FIG. 1 illustrates a configuration of a metal-air battery 1 according to an embodiment of the present invention. The metal-air battery 1 in FIG. 1 is a secondary battery using zinc ions, i.e., a zinc-air secondary battery. The metal-air battery may use other metal ions. The metal-air battery 1 has a main body 11 having a generally columnar shape centered on a central axis J1, and FIG. 1 illustrates a cross section of the main body 11 (excluding a negative electrode 3, which will be described later) in a plane perpendicular to the central axis J1. The metal-air battery 1 includes a positive electrode 2, the negative electrode 3, and an electrolyte layer 4.

The negative electrode 3 (also referred to as a “metal electrode”) is a coiled member centered on the central axis J1. The negative electrode 3 according to the present embodiment is shaped by winding a linear member having a generally circular cross-sectional shape in a spiral about the central axis J1. The negative electrode 3 includes a coiled base member made of a conductive material, and a deposited metal layer formed on a surface of the base member. An end of the negative electrode 3 in the direction of the central axis J1 is connected to a negative electrode current collecting terminal (not shown).

Examples of the material for the aforementioned base member include metals such as copper (Cu), nickel (Ni), silver (Ag), gold (Au), iron (Fe), aluminum (Al), and magnesium (Mg) and alloys containing any of these metals. In the present embodiment, the base member is made of copper. From the viewpoint of increasing the conductivity of the base member serving also as a current collector, the base member preferably contains copper or a copper alloy. When the main body of the base member is made of copper, it is preferable to form a protective film of another metal such as nickel on a surface of the main body. In this case, the surface of the base member is a surface of the protective film. For example, the protective film has a thickness of 1 to 20 micrometers (μm) and is formed by plating. The deposited metal layer is formed by electrodeposition of zinc (Zn). Alternatively, the deposited metal layer may be formed by electrodeposition of an alloy containing zinc. Depending on the design of the metal-air battery 1, the negative electrode 3 may have a tubular or rod-like shape.

A cylindrical separator 41 is provided on the periphery of the negative electrode 3, and the cylindrical positive electrode 2 (also referred to as an “air electrode”) is provided on the periphery of the separator 41. That is, the inner side surface of the separator 41 faces the negative electrode 3, and the outer side surface of the separator 41 faces the inner side surface of the positive electrode 2. The negative electrode 3, the separator 41, and the positive electrode 2 are provided concentrically about the central axis J1, and the distance between the outer edge of the negative electrode 3 and the positive electrode 2, when viewed in the direction of the central axis J1, is constant along the entire circumference in a circumferential direction about the central axis J1. That is, the interval between equipotential surfaces of the negative electrode 3 and the positive electrode 2 in the metal-air battery 1 is constant along the entire circumference. Since there is no unevenness of the equipotential surfaces, the current distribution in the circumferential direction is constant during charge and discharge. Note that the positive electrode 2 may have, for example, a tubular regular polygonal shape having six or more vertices as long as the current distribution is approximately uniform along the entire circumference. The details of the separator 41 will be described later.

The positive electrode 2 includes a porous positive electrode main body 21 that is made of conductive ceramic and serves as a tubular supporter, and a positive electrode catalyst layer 22 that is formed on the outer side surface of the positive electrode main body 21 on the side opposite to the negative electrode 3. Preferably, the positive electrode catalyst layer 22 is formed on the entire periphery of the positive electrode main body 21. An interconnector 24 made of ceramic having alkali resistance is provided on part of the outer side surface of the positive electrode catalyst layer 22. The interconnector 24 has a thickness of, for example, approximately 30 to 300 m. The interconnector 24 is connected to a positive electrode current collecting terminal (not shown). On the area of the outer side surface of the positive electrode catalyst layer 22 that is not covered with the interconnector 24, a porous layer made of a material having liquid repellent properties (e.g., tetrafluoroethylene-hexafluoropropylene copolymer (FEP) or polytetrafluoroethylene (PTFE)) is formed as a liquid repellent layer 29. The liquid repellent layer 29 has high gas permeability and high liquid impermeability.

The positive electrode main body 21 serving as a positive electrode conductive layer is formed by extrusion molding and firing of a material that contains conductive ceramic. Preferable examples of the conductive ceramic include perovskite type oxides and spinel type oxides, both having conductivity. In the present embodiment, the positive electrode main body 21 is formed of a perovskite type oxide (e.g., LaSrMnO₃ (LSM), LaSrMnFeO₃ (LSMF), or LaSrCoFeO₃ (LSCF)). The perovskite type oxide used for the positive electrode main body 21 preferably contains at least one of Co, Mn, and Fe. From the viewpoint of preventing degradation of the positive electrode main body 21 due to oxidation during charge, it is preferable for the positive electrode main body 21 to not contain conductive carbon. The positive electrode main body 21 may be made of other conductive ceramic. The gas permeability of the positive electrode main body 21 is preferably higher than or equal to 2000 m³/(m²·h·atm). In this case, the porosity of the positive electrode main body 21 is preferably 30% or above. When the porosity is less than 30%, the gas permeability excessively decreases. The porosity of the positive electrode main body 21 is also preferably 80% or less. If the porosity is above 80%, the strength of the positive electrode main body 21 serving as a supporter decreases.

The positive electrode catalyst layer 22 includes a portion in which conductive ceramic powder such as a perovskite type oxide (e.g., LSM, LSCF, or LSMF) is supported on the positive electrode main body 21 by, for example, a slurry coating method and firing. The positive electrode catalyst layer 22 is a porous film made of ceramic and formed on the outer side surface of the positive electrode main body 21 on the side opposite to the negative electrode 3, and is supported by the positive electrode main body 21 serving as a supporter. For example, the positive electrode catalyst layer 22 has a thickness sufficiently smaller than the thickness of the positive electrode main body 21. In the metal-air battery 1, in principle, an interface between the air and an electrolyte solution 40, which will be described later, is formed in the vicinity of the porous positive electrode catalyst layer 22.

The separator 41 described previously is a porous film formed on the inner side surface of the positive electrode main body 21 on the negative electrode 3 side, and is formed along the entire circumference on the inner side surface. For example, the separator 41 may be a sintered compact of ceramic powder having high mechanical strength and high insulating properties, such as silica (SiO₂), alumina (Al₂O₃), zirconia (ZrO₂), titania (TiO₂), hafnia (HfO₂), or ceria (CeO₂), and may have high alkali resistance. As will be described later, the production of the separator 41 involves depositing slurry that contains the aforementioned ceramic powder and a binder on the inner side surface of the positive electrode main body 21 by using, for example, a slurry coating method, drying the slurry and removing the binder contained in the slurry by firing at a high temperature. The removal of the binder prevents the separator from having a short lifetime due to degradation of the binder. The separator 41 is preferably configured of only ceramic. Alternatively, the separator 41 may be a mixture or laminated body of the aforementioned kinds of ceramic.

The aforementioned ceramic powder preferably has an average particle diameter larger than or equal to 0.1 μm and smaller than or equal to 30 μm, and the particle diameters may be adjusted by sizing as necessary. The average pore diameter of the separator 41 is preferably larger than or equal to 0.01 μm and smaller than or equal to 2 μm. The separator having such an average pore diameter can prevent deposited metal (e.g., dendrites) on the negative electrode 3 from penetrating the separator 41. The average pore diameter of the separator 41 is also preferably smaller than the average pore diameter of the positive electrode main body 21. The thickness (wall thickness) of the cylindrical separator 41 is greater than or equal to 50 μm and less than or equal to 200 μm, and is preferably smaller than the thickness of the positive electrode main body 21.

The space on the inner side (central axis J1 side) of the tubular positive electrode 2 is filled with the water-based electrolyte solution 40. The electrolyte solution 40 exists between and in contact with the positive electrode 2 and the negative electrode 3. The negative electrode 3 is immersed in almost its entirety in the electrolyte solution 40. The pores of the porous separator 41 and the porous positive electrode main body 21 are also filled with the electrolyte solution 40. Some pores of the positive electrode catalyst layer 22 are also filled with the electrolyte solution 40. In the following description, the space between the negative electrode 3 and the positive electrode 2, when viewed in the direction along the central axis J1, is referred to as the “electrolyte layer 4.” That is, the electrolyte layer 4 is disposed between the negative electrode 3 and the positive electrode 2. In the present embodiment, the electrolyte layer 4 includes the separator 41.

The electrolyte solution 40 is an aqueous alkaline solution that preferably contains an aqueous potassium hydroxide (caustic potash, KOH) solution or an aqueous sodium hydroxide (caustic soda, NaOH) solution. The electrolyte solution 40 also contains zinc ions or ions containing zinc. That is, zinc ions contained in the electrolyte solution 40 may be in various forms and may be regarded as ions containing zinc (i.e., atoms of zinc). For example, zinc ions may exist as tetrahydroxy zinc ions.

The opposite end surfaces of the negative electrode 3, the electrolyte layer 4, and the positive electrode 2 in the direction of the central axis J1 are fixed to disc-like closure members. Each closure member has a through hole in the center. In the metal-air battery 1, the liquid repellent layer 29 and the closure members prevent the electrolyte solution 40 in the main body 11 from leaking out from portions other than the aforementioned through holes to the outside. The electrolyte solution may also be circulated between the main body 11 and a reservoir tank (not shown) by using the through holes of the closure members on the opposite end surfaces.

During discharge in the metal-air battery 1 in FIG. 1, the negative electrode current collecting terminal and the positive electrode current collecting terminal are electrically connected to each other via, for example, a load such as lighting equipment. Zinc contained in the negative electrode 3 is oxidized into zinc ions, and electrons therein are supplied via the negative electrode current collecting terminal and the positive electrode current collecting terminal to the positive electrode 2. In the porous positive electrode 2, oxygen from the air, which has passed through the liquid-repellent layer 29, is reduced by the electrons supplied from the negative electrode 3 and dissolved as hydroxide ions in the electrolyte solution. In the positive electrode 2, the positive electrode catalyst accelerates oxygen reduction reactions.

On the other hand, during charge in the metal-air battery 1, a voltage is applied between the negative electrode current collecting terminal and the positive electrode current collecting terminal, so that electrons are supplied from hydroxide ions to the positive electrode 2 and oxygen is generated. In the negative electrode 3, metal ions are reduced by the electrons supplied to the negative electrode current collecting terminal via the positive electrode current collecting terminal, and zinc is deposited.

At this time, electric field concentrations are less likely to occur because the coiled negative electrode 3 has no corners. That is, a large imbalance in current density does not occur. In addition, the negative electrode 3 is uniformly in contact with the electrolyte solution 40. This considerably suppresses generation and growth of zinc dendrites deposited in dendritic form and zinc whiskers deposited in whisker form (needle-like form). In actuality, close-grained zinc is uniformly deposited on almost the entire surface of the negative electrode 3, and a deposited metal layer is formed thereon. In the positive electrode 2, the positive electrode catalyst contained in the positive electrode catalyst layer 22 accelerates oxygen generation. Moreover, the positive electrode 2 does not suffer from oxidation degradation caused by oxygen generated during charge, because no carbon material is used for the positive electrode 2.

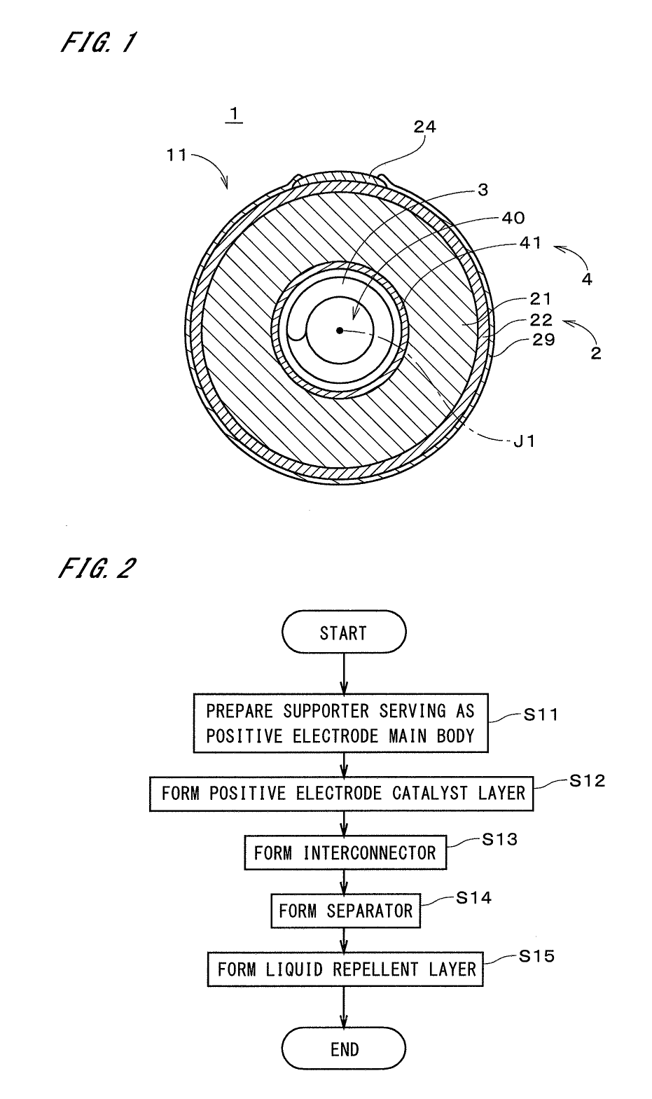

As described above, in the metal-air battery 1, the positive electrode main body 21 is used as a supporter, the positive electrode catalyst layer 22 is formed on the outer side surface of the positive electrode main body 21, and the separator 41 is formed on the inner side surface of the positive electrode main body 21. That is, the separator 41 and the positive electrode 2 are produced as an integral member. FIG. 2 illustrates the procedure for producing the positive electrode 2 provided with the separator 41. FIG. 2 illustrates a basic procedure for producing the positive electrode 2, and the order of processing may be appropriately changed.

In the production of the positive electrode 2, first, the cylindrical positive electrode main body 21 is formed as a porous supporter by extrusion molding and firing of a positive electrode forming material that contains conductive ceramic (step S11). Examples of the conductive ceramic include perovskite type oxides, and here, LSM or LSCF is used. From the viewpoint of securing high conductivity of the positive electrode main body 21 serving as a positive electrode conductive layer and also securing the function of the positive electrode main body 21 as a catalyst for oxygen generation reaction, it is preferable to use LSCF.

Before firing, the compact may be subjected to heat treatment at a temperature of 100 to 800° C. to decompose and remove organic components in the compact. The firing is preferably conducted at a temperature of 900 to 1500° C. with use of any conditions as long as the compact can be sintered sufficiently and properties such as gas permeability, electrolyte permeability, and battery performance can be ensured. Alternatively, the compact may be co-fired with other layers, which will be described alter. The co-firing helps improve the adhesive strength between the compact and the other layers. The co-firing also helps reduce the lead time of the firing step, as compared with the case where each layer is fired individually. The positive electrode main body 21 may be formed by techniques other than extrusion molding and firing.

After the positive electrode main body 21 is prepared, slurry that contains a positive electrode catalyst is deposited on the outer side surface of the positive electrode main body 21 by a slurry coating method and then fired with the positive electrode main body 21 to form the positive electrode catalyst layer 22 (step S12). Examples of the positive electrode catalyst include ceramic such as perovskite type oxides, and here, LSM, LSCF, or LSMF is used. At this time, the ceramic of the positive electrode catalyst layer 22 has a crystal structure identical to that of the conductive ceramic of the positive electrode main body 21. This reduces a difference in the coefficient of thermal expansion between the positive electrode main body 21 and the positive electrode catalyst layer 22 and suppresses generation of cracks and delamination due to firing.

The formation (deposition) of the slurry film may use various techniques such as casting, dipping, spraying, and printing. The thickness of each layer of the positive electrode 2 is appropriately adjusted in consideration of firing shrinkage during firing and from the viewpoint of securing properties relating to battery performance, such as gas permeability and electrolyte permeability. The positive electrode catalyst layer 22 may be formed by techniques other than the aforementioned deposition and firing (the same applies to the interconnector 24, the separator 41, and the liquid repellent layer 29).

After the positive electrode catalyst layer 22 is formed, the outer side surface of the positive electrode catalyst layer 22, excluding a given area, is masked. Then, slurry that contains fine powder such as a perovskite type oxide is used to form a film on that area by a slurry coating method, and the film is fired with the positive electrode main body 21 and the positive electrode catalyst layer 22 to form the interconnector 24 (step S13).

After the interconnector 24 is formed, slurry that contains a separator forming material is deposited on the inner side surface of the positive electrode main body 21 by a slurry coating method, and fired with the positive electrode main body 21, the positive electrode catalyst layer 22, and the interconnector 24 to form the separator 41 (step S14). Examples of the separator forming material include ceramic having insulating properties, and here, alumina or zirconia is used. In the firing of the separator 41, a binder contained in the slurry is preferably removed.

After the separator 41 is formed, slurry that contains a liquid repellent material is deposited on the outer side surface of the positive electrode catalyst layer 22 by a slurry coating method, and fired with the positive electrode main body 21, the positive electrode catalyst layer 22, the interconnector 24, and the separator 41 to form the liquid repellent layer 29 (step S15). At the time of deposition of the slurry containing a liquid repellent material, the area of the interconnector 24 is preferably masked. Examples of the liquid repellent material include FEP and PTFE. The depth of impregnation of the slurry in the depth direction of the positive electrode catalyst layer 22 is adjusted by adding the required amount of a thickener to the slurry to adjust the viscosity of the slurry. This adjustment allows three-phase interfaces to be formed in the vicinity of the positive electrode catalyst layer 22 in the metal-air battery 1 while preventing the surfaces of particles in the pores of the positive electrode catalyst layer 22 from being completely covered with the liquid repellent material.

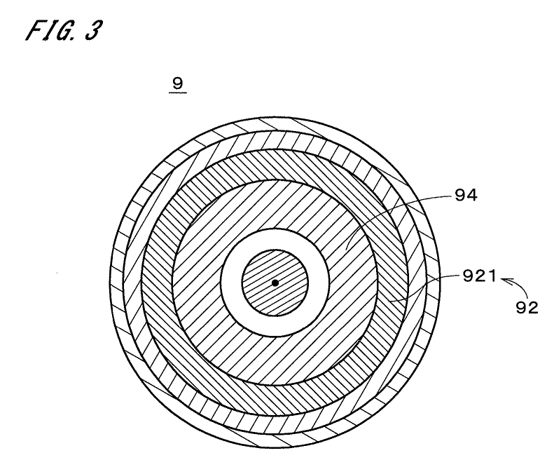

Here, a metal-air battery according to a comparative example is assumed in which a separator is used as a supporter. FIG. 3 is a cross-sectional view corresponding to FIG. 1 and illustrates a configuration of a metal-air battery 9 according to a comparative example. In the metal-air battery 9 according to the comparative example, a separator 94 made of alumina serves as a tubular supporter, and a positive electrode conductive layer 921 and other layers are formed on the outer side surface of the separator 94. The positive electrode 92 is formed to a predetermined thickness by repeating multiple times film deposition of slurry that contains a perovskite type oxide by using a slurry coating method and firing.

In the metal-air battery 9 according to the comparative example, film deposition and firing have to be repeated many times in order to increase the thickness of the positive electrode 92, and therefore the manufacture of the (positive electrode 92 of) metal-air battery 9 becomes complicated. In addition, cracks and delamination are likely to occur in the positive electrode 92. In actuality, there is a certain limit to increasing the thickness of the positive electrode 92 due to manufacturing cost and other factors. Thus, in the metal-air battery 9 according to the comparative example, the positive electrode 92 has a relatively small thickness. As a result, the electrical resistance of the positive electrode 92 increases, and it becomes difficult to improve battery performance.

In contrast, in the metal-air battery 1 in FIG. 1, the positive electrode 2 includes the porous positive electrode main body 21 that is made of conductive ceramic and serves as a tubular supporter, and the separator 41 that is a porous film made of ceramic having insulating properties is provided on the inner side surface of the positive electrode main body 21. In this way, using the positive electrode main body 21 as a supporter makes it possible to easily increase the thickness of the positive electrode 2 and to thereby reduce the electrical resistance of the positive electrode 2 and improve the battery performance of the metal-air battery 1. Additionally, the number of steps of manufacturing the metal-air battery 1 can be reduced (simplified) because there is no need to repeat slurry coating and firing to increase the thickness of the positive electrode 2 as in the comparative example in which the separator is used as a supporter. Moreover, the thickness of the separator 41 in the metal-air battery 1, which does not use the separator 41 as a supporter, can be reduced considerably as compared with the separator in the metal-air battery 9 according to the comparative example in which the separator 94 is used as a supporter. As a result, it is possible to reduce the distance between the negative electrode 3 and the positive electrode 2 and to further improve the battery performance of the metal-air battery 1. It is also possible to suppress generation of cracks and delamination at the time of formation of the separator 41.

In the metal-air battery 1 in FIG. 1, the positive electrode main body 21 of greater thickness than the separator 41 allows the distance between the negative electrode 3 and the positive electrode 2 to be reduced while reducing the electrical resistance of the positive electrode 2, thus further improving the battery performance of the metal-air battery 1. The thickness of the positive electrode main body 21 is preferably greater than three times the thickness of the separator 41 and more preferably greater than five times the thickness of the separator 41.

As described previously, in the metal-air battery 1, an interface between the electrolyte solution and air is formed in the positive electrode catalyst layer 22. During discharge in the metal-air battery 1, oxygen reduction reactions in which hydroxide ions are generated from oxygen from the air and water in the electrolyte solution occur mainly in the positive electrode catalyst layer 22. Thus, the positive electrode catalyst layer 22 may be regarded as a discharge reaction layer and is preferably made of ceramic that is superior in oxygen reduction reaction to the conductive ceramic of the positive electrode main body 21. If a catalyst for oxygen reduction reactions is used for the positive electrode catalyst layer 22, which is in contact with oxygen serving as an active material in oxygen reduction reactions, out of the positive electrode main body 21 and the positive electrode catalyst layer 22, the active material is efficiently supplied to the catalyst. In this case, concentration overvoltage can be reduced, and the discharge performance of the metal-air battery 1 can be improved.

On the other hand, during charge in the metal-air battery 1, oxygen generation reactions in which oxygen and water are generated from hydroxide ions in the electrolyte solution occur mainly in the positive electrode main body 21 serving as a positive electrode conductive layer. Thus, the positive electrode main body 21 may be regarded as a charge reaction layer and is preferably made of conductive ceramic that is superior in oxygen generation reaction to the ceramic of the positive electrode catalyst layer 22. If a catalyst for oxygen generation reactions is used for the positive electrode main body 21, which is filled with (the electrolyte solution containing) hydroxide ions serving as an active material in oxygen generation reactions, out of the positive electrode main body 21 and the positive electrode catalyst layer 22, the active material is efficiently supplied to the catalyst. In this case, concentration overvoltage can be reduced, and the charge performance of the metal-air battery 1 can be improved.

Here, the superiority of oxygen reduction reactions and oxygen generation reactions may be evaluated using, for example, a technique described in Japanese Patent Application Laid-Open No. 2005-190833 (Document 3). That is, the technique involves forming gas-diffusion type electrodes that use various materials as their catalysts, causing oxygen reduction reactions and oxygen generation reactions to occur, and measuring its voltage with reference to a reference electrode that indicates a predetermined electrode current density. It can be said that the material with higher voltage in oxygen reduction reaction is more superior in oxygen reduction reaction, and the material with lower voltage in oxygen generation reaction is more superior in oxygen generation reaction.

Preferable materials for the positive electrode catalyst layer 22 and the positive electrode main body 21 are perovskite type oxides. Perovskite type oxides are expressed by ABO₃, where A is an alkali metal, an alkaline-earth metal, or a rare-earth metal, and B is a transition metal. A preferable material for the positive electrode catalyst layer 22 is configured such that the A-site of a perovskite type oxide consists of at least one of La, Sr, and Ca, and the B-site consists of at least one of Fe, Ni, Co, and Mn. A preferable material for the positive electrode main body 21 is configured such that the A-site of a perovskite type oxide consists of at least one of La and Sr, and the B-site consists of at least one of Co and Fe (here, the material is preferably different from the material for the positive electrode catalyst layer 22). For example, when the positive electrode catalyst layer 22 serving as a discharge reaction layer is made of LSM or LSMF and the positive electrode main body 21 serving as a charge reaction layer is made of LSCF, the ceramic of the positive electrode catalyst layer 22 is superior in oxygen reduction reaction to the ceramic of the positive electrode main body 21, and the ceramic of the positive electrode main body 21 is superior in oxygen generation reaction to the ceramic of the positive electrode catalyst layer 22.

The average particle diameter of ceramic particles of the positive electrode catalyst layer 22 is preferably larger than or equal to 1 μm in order to ensure a certain degree of gas diffusion properties during discharge reactions, and is also preferably smaller than or equal to 10 μm in order to secure a certain amount of reaction area. By so doing, the discharge performance of the metal-air battery 1 can be further improved. The average particle diameter of conductive ceramic particles of the positive electrode main body 21 is preferably larger than or equal to 0.1 μm in order to secure pores in a range of sizes enough to hold the electrolyte solution, and is also preferably smaller than or equal to 2 μm in order to secure a certain amount of reaction area during charge reactions. By so doing, the charge performance of the metal-air battery 1 can be further improved. The average particle diameters of ceramic particles may be determined by, for example, an intercept method using a scanning electron microscopy image of a smooth surface obtained by grinding a cross-section of the positive electrode 2.

### Example 1

Based on a cylindrical perovskite oxide porous ceramic support tube (LSM with an average pore diameter of 5 μm) manufactured by Hitachi Zosen Corporation through extrusion molding and high-temperature firing and having a thickness of 2 mm, an outer diameter of 16 mm, an inner diameter of 12 mm, and a length of 70 mm, a positive electrode (air electrode) provided with a separator was produced by deposition and firing using a slurry coating method in steps in decreasing order of firing temperature as described below. Hereinafter, this ceramic support tube is referred to as a “ceramic tube.”

### Preparation 1 of Slurry for Separator

Slurry used to deposit first and second layers of the separator was prepared as described below. First, 3.4% by weight of a binder (ethyl cellulose) was added in small amounts to a solution that contained alcohol (SOLMIX; registered trademark) and 2-(2-n-butoxyethoxy)ethyl acetate in the ratio of 3:1, while stirring the solution in order not to form a cluster of the binder. The solution was stirred until the binder was dissolved and the solution became transparent. The solution obtained as described above was poured into a pot mill that previously contained 32% by weight of alumina powder (e.g., A-42-6 manufactured by SHOWA DENKO K.K.) and a resin ball with a diameter of 10 mm, and combined and stirred for 10 days or more using a ball mill.

Deposition 1 of Separator

A hose-like cap (playing a role of a funnel) was placed on the upper end of the above cylindrical ceramic tube, and a sealing stopper was placed on the lower end thereof. The hose-like cap on the upper end was placed to prevent overflow of the slurry. By using the funnel, the slurry used to deposit the first and second layers was injected into the ceramic tube from the upper end covered with the hose-like cap, and the ceramic tube filled up with the slurry was held for one minute. After the elapse of one minute, the sealing stopper on the lower end was removed to discharge the slurry. Thereafter, the ceramic tube was dried at ambient temperature for 15 hours or more and then at 50° C. for two hours or more. This operation was repeated once again after the ceramic tube was placed upside down. Thereafter, the ceramic tube was fired at 1250° C. for four hours to obtain a ceramic tube having two layers of alumina film on the inner side surface.

Preparation of Slurry for Catalyst Layer

Slurry for the catalyst layer was prepared as described below. First, 3.4% by weight of a binder (ethyl cellulose) was added in small amounts to a solution that contained alcohol (SOLMIX (registered trademark) H-37) and 2-(2-n-butoxyethoxy)ethyl acetate in the ratio of 3:1, while stirring the solution in order not to form a cluster of the binder. The solution was stirred until the binder was dissolved. The solution obtained as described above was poured into a pot mill that previously contained 32% by weight of LaSrCoFeO₃ raw powder and a resin ball with a diameter of 10 mm, and combined and stirred for 10 days or more using a ball mill.

Deposition of Catalyst Layer

Sealing stoppers were placed on the upper and lower ends of the above cylindrical ceramic tube to prevent the slurry from entering the inside of the tube. The ceramic tube was immersed fully to the upper end in the slurry and held for one minute. After the elapse of one minute, the ceramic tube was pulled out of the slurry to let the slurry drip away. Thereafter, the ceramic tube was dried at 35° C. for 30 minutes or more and at 80° C. for two hours or more. The dried ceramic tube was then fired at 1150° C. for five hours to obtain a ceramic tube having a positive electrode catalyst layer formed on the outer side surface.

Preparation of Slurry for Interconnector

Slurry used to deposit the interconnector was prepared in the following procedure. First, 4% by weight of a binder (ethyl cellulose manufactured by Tokyo Chemical Industry Co., Ltd.) was added in small amounts to a solution that contained SOLMIX (registered trademark) H-37 (manufactured by Japan Alcohol Trading Co., Ltd.) and 2-(2-n-butoxyethoxy)ethyl acetate (manufactured by Kanto Chemical Co., INC.) in the ratio of 3:1, while stirring the solution in order not to form a cluster of the binder, and the solution was stirred until the binder was dissolved. The solution obtained as described above was poured into a pot mill together with 27% by weight of LaSrCoFeO₃ (LSCF) powder with an average particle diameter of 3.7 μm and a resin ball with a diameter of 10 mm, and combined for 50 hours using a ball mill to obtain the slurry for the interconnector.

Deposition of Interconnector

In the outer side surface of the ceramic tube on which the positive electrode catalyst layer was formed, an area that is other than an area where the interconnector with a width of 5 mm and a length of 60 mm was to be formed, was covered with a masking tape. The masked ceramic tube was immersed in the LSCF slurry for one minute and dried at 35° C. for 30 minutes and then at 80° C. for 90 minutes or more. After this operation was repeated five times, the masking tape was removed and the ceramic tube was fired at 1150° C. for four hours to obtain a ceramic tube having an interconnector on the outer side surface of the positive electrode catalyst layer.

Preparation 2 of Slurry for Separator

Slurry used to deposit third and fourth layers of the separator was prepared as described below. First, 2.9% by weight of a binder (ethyl cellulose) was added in small amounts to a solution that contained alcohol (SOLMIX; registered trademark) and 2-(2-n-butoxyethoxy)ethyl acetate in the ratio of 3:1, while stirring the solution in order not to form a cluster of the binder. The solution was stirred until the binder was dissolved and the solution became transparent. The solution obtained as described above was poured into a nylon rein pot mill that previously contained 20% by weight of zirconia powder (e.g., TZ-0 manufactured by Tosoh Corporation) and a nylon resin ball with a diameter of 10 mm, and combined and stirred for 10 days or more using a ball mill.

Deposition 2 of Separator

A hose-like cap was placed on the upper end of the ceramic tube having two layers of alumina film laminated on the inner side surface, and a sealing stopper was placed on the lower end thereof. By using the funnel, the slurry used to deposit the third and fourth layers was injected from the upper end of the ceramic tube covered with the hose-like cap, and the ceramic tube filled fully to the top with the slurry was held for one minute. After the elapse of one minute, the sealing stopper on the lower end was removed to discharge the slurry. Thereafter, the ceramic tube was dried at ambient temperature for 15 hours or more and then at 50° C. for two hours or more. The dried ceramic tube was then fired at 1000° C. for four hours to obtain a ceramic tube having three layers of film (two layers of alumina film and single layer of zirconia film) laminated on the inner side surface.

Next, the ceramic tube was placed upside down, opposite to the way in which the third layer was deposited, and a hose-like tube was placed on the upper end and a sealing stopper was placed on the lower end in the same way. Then, the same slurry as used to deposit the third layer was injected from the upper end of the ceramic tube covered with the hose-like cap, and the ceramic tube filled fully to the top with the slurry was held for one minute. After the elapse of one minute, the sealing stopper on the lower end was removed to discharge the slurry. Thereafter, the ceramic tube was dried at ambient temperature for 15 hours or more and then at 50° C. for two hours or more. The dried ceramic tube was then fired at 1000° C. for four hours to obtain a ceramic tube having four layers of film (two layers of alumina film and two layers of zirconia film) laminated on the inner side surface.

Preparation of Slurry for Liquid Repellent Layer

First, undiluted FEP dispersion manufactured by Du Pont-Mitsui Fluorochemicals Co., Ltd. was diluted to 20 wt %, and 2.8% by weight of ALKOX (registered trademark) E-30 serving as a thickener was weighed and added in small amounts to the diluted FEP solution, while stirring the solution in order not to form a cluster of the thickener.

Deposition of Liquid Repellent Layer

The interconnector area of the ceramic tube was covered with a tape so that a portion of the liquid repellent layer (water repellent layer) that overlapped with the interconnector had a width of 1 mm. The ceramic tube was then immersed in the aforementioned dispersion for one minute, dried at ambient temperature for 30 minutes and then at 60° C. for 15 hours, and fired at 280° C. for 50 minutes to obtain a ceramic tube having a liquid repellent layer.

Sample Evaluation

The gas permeability of the obtained samples was evaluated by an N₂ gas permeability test, and the anti-water pressure characteristics of the samples were evaluated by an anti-water pressure test. The gas permeability of the cylindrical perovskite oxide porous ceramic tube was 2027 m³/(m²·h·atm), whereas the gas permeability of the ceramic tube including the separator, the positive electrode catalyst layer, the interconnector, and the liquid repellent layer was 117 m³/(m²·h·atm). The result of the anti-water pressure test in which the inside of the ceramic tube was filled with water and gradually pressurized with an N₂ gas showed that leakage was confirmed at 0.045 MPa.

Evaluation of Battery Performance

A Cu coil (negative electrode) having 2 g of electrodeposited Zn was inserted into each obtained positive electrode (air electrode), an electrolyte solution (7M KOH+0.65 M ZnO) was circulated inside the positive electrode, and battery performance was evaluated at ambient temperature. As a result, the voltage was 0.69V and the power density was 0.038 W/cm² at a current density of 54.5 mA/cm² during discharge. During charge, the voltage was 2.05V at a current density of 52.9 mA/cm². It can be regarded that the discharge performance is high when the discharge voltage is high and when the power density is high (power density (W/cm²)=current density (A/cm²)×voltage (V)). It can be regarded that the charge performance is high when the charge voltage is low.

### Comparative Example 1

Based on a cylindrical alumina porous ceramic tube (Al₂O₃ with an average pore diameter of 10 μm) manufactured by Hitachi Zosen Corporation through extrusion molding and high-temperature firing and having a thickness of 2 mm, an outer diameter of 16 mm, an inner diameter of 12 mm, and a length of 70 mm, a positive electrode according to a comparative example was produced by deposition and firing using a slurry coating method in steps in descending order of firing temperature as described below. The positive electrode according to the comparative example includes a buffer layer that suppresses formation of a reaction phase at an interface between a conductive layer and a separator, which will be described later.

Preparation of Slurry for Buffer Layer

Slurry for the buffer layer was prepared as described below. First, 3.4% by weight of a binder (ethyl cellulose) was added in small amounts to a solution that contained alcohol (SOLMIX (registered trademark) H-37) and 2-(2-n-butoxyethoxy)ethyl acetate in the ratio of 3:1, while stirring the solution in order not to form a cluster of the binder. The solution was stirred until the binder was dissolved. The solution obtained as described above was poured into a pot mill that previously contained 32% by weight of LaSrCoMnFeO₃ raw powder and a resin ball with a diameter of 10 mm, and combined and stirred for 10 days or more using a ball mill.

Preparation of Slurry for Conductive Layer

Slurry for the conductive layer was prepared as described below. First, 3.4% by weight of a binder (ethyl cellulose) was added in small amounts to a solution that contained alcohol (SOLMIX (registered trademark) H-37) and 2-(2-n-butoxyethoxy)ethyl acetate in the ratio of 3:1, while stirring the solution in order not to form a cluster of the binder. The solution was stirred until the binder was dissolved. The solution obtained as described above was poured into a pot mill that previously contained 32% by weight of LaSrCoFeO₃ raw powder and a resin ball with a diameter of 10 mm, and combined and stirred for 10 days or more using a ball mill.

Preparation of Slurry for Catalyst Layer

Slurry for the catalyst layer was prepared as described below. First, 3.4% by weight of a binder (ethyl cellulose) was added in small amounts to a solution that contained alcohol (SOLMIX (registered trademark) H-37) and 2-(2-n-butoxyethoxy)ethyl acetate in the ratio of 3:1, while stirring the solution in order not to form a cluster of the binder. The solution was stirred until the binder was dissolved. The solution obtained as described above was poured into a pot mill that previously contained 32% by weight of LaSrMnFeO₃ raw powder and a resin ball with a diameter of 10 mm, and combined and stirred for 10 days or more using a ball mill.

Deposition of Buffer Layer, Conductive Layer, and Catalyst Layer

Sealing stoppers were placed on the upper and lower ends of the above cylindrical ceramic tube to prevent the slurry from entering the inside of the tube. The ceramic tube was then immersed fully to the upper end in the slurry for the buffer layer and held for one minute. After the elapse of one minute, the ceramic tube was pulled out of the slurry to let the slurry drip away. Thereafter, the ceramic tube was dried at 35° C. for 30 minutes or more and then at 80° C. for 90 minutes or more. This operation was repeated twice.

Next, the ceramic tube was immersed fully to the upper end in the slurry for the conductive layer and held for one minute. After the elapse of one minute, the ceramic tube was pulled out of the slurry to let the slurry drip away. Thereafter, the ceramic tube was dried at 35° C. for 30 minutes or more and then at 80° C. for 90 minutes or more. After a total of three times of immersion and drying of the buffer layer and the conductive layer, the ceramic tube (supporter) was fired at 1325° C. for four hours.

The ceramic tube was further immersed fully to the upper end in the slurry for the conductive layer and held for one minute. After the elapse of one minute, the ceramic tube was pulled out of the slurry to let the slurry drip away. Thereafter, the ceramic tube was dried at 35° C. for 30 minutes or more and then at 80° C. for 90 minutes or more. This operation was repeated three times, and thereafter the ceramic tube was fired at 1325° C. for four hours.

The ceramic tube was further immersed fully to the upper end in the slurry for the conductive layer and held for one minute. After the elapse of one minute, the ceramic tube was pulled out of the slurry to let the slurry drip away. Thereafter, the ceramic tube was dried at 35° C. for 30 minutes or more and then at 80° C. for 90 minutes or more. After this operation was repeated three times, the ceramic tube was immersed fully to the upper end in the slurry for the catalyst layer and held for one minute. After the elapse of one minute, the ceramic tube was pulled out of the slurry to let the slurry drip away. Thereafter, the ceramic tube was dried at 35° C. for 30 minutes or more and then at 80° C. for 90 minutes or more. After a total of four times of immersion and drying of the conductive layer and the catalyst layer, the ceramic tube was fired at 1325° C. for four hours.

Through the steps described above, the ceramic tube including the buffer layer, the conductive layer, and the catalyst layer was obtained.

Preparation 1 of Slurry for Separator

Slurry used to deposit first and second layers of the separator was prepared as described below. First, 3.4% by weight of a binder (ethyl cellulose) was added in small amounts to a solution that contained alcohol (SOLMIX; registered trademark) and 2-(2-n-butoxyethoxy)ethyl acetate in the ratio of 3:1, while stirring the solution in order not to form a cluster of the binder. The solution was stirred until the binder was dissolved and the solution became transparent. The solution obtained as described above was poured into a pot mill that previously contained 32% by weight of alumina powder (e.g., A-42-6 manufactured by SHOWA DENKO K.K.) and a resin ball with a diameter of 10 mm, and combined and stirred for 10 days or more using a ball mill.

Deposition 1 of Separator

A hose-like cap (playing a role of a funnel) was placed on the upper end of the above cylindrical ceramic tube, and a sealing stopper was placed on the lower end thereof. The hose-like cap on the upper end was placed to prevent overflow of the slurry. By using the funnel, the slurry used to deposit the first layer was injected from the upper end of the ceramic tube covered with the hose-like cap, and the ceramic tube filled fully to the top was held for one minute. After the elapse of one minute, the sealing stopper on the lower end was removed to discharge the slurry. Thereafter, the ceramic tube was dried at ambient temperature for 15 hours or more and then at 50° C. for two hours or more. After this operation was repeated twice, the ceramic tube was fired at 1250° C. for hour hours to obtain a ceramic tube having two layers of alumina film lamented on the inner side surface. Note that the pore diameters of the alumina film were smaller than the pore diameters of the ceramic tube, and the alumina film was deposited to prevent penetration of dendrites (the same applies a zirconia film described later).

Preparation of Slurry for Interconnector

Slurry used to deposit the interconnector was prepared in the following procedure. First, 4% by weight of a binder (ethyl cellulose manufactured by Tokyo Chemical Industry Co., Ltd.) was added in small amounts to a solution that contained SOLMIX (registered trademark) H-37 (manufactured by Japan Alcohol Trading Co., Ltd.) and 2-(2-n-butoxyethoxy)ethyl acetate (manufactured by Kanto Chemical Co., INC.) in the ratio of 3:1, while stirring the solution in order not to form a cluster of the binder. The solution was stirred until the binder was dissolved. The solution obtained as described above was poured into a pot mill together with 27% by weight of LaSrCoFeO₃ powder with an average particle diameter of 3.7 μm and a resin ball with a diameter of 10 mm, and combined for 50 hours using a ball mill to obtain the slurry for the interconnector.

Deposition of Interconnector

In the outer side surface of the above ceramic tube having the catalyst layer, an area which is other than an area where the interconnector with a width of 5 mm and a length of 60 mm was to be formed, was covered with a masking tape. The masked ceramic tube was immersed in the LSCF slurry for one minute, and dried at 35° C. for 30 minutes and then at 80° C. for 90 minutes or more After this operation was repeated five times, the masking tape was removed and the ceramic tube was fired at 1150° C. for four hours to obtain a ceramic tube having an interconnector.

Preparation 2 of Slurry for Separator

Slurry used to deposit third and fourth layers of the separator was prepared as described below. First, 2.9% by weight of a binder (ethyl cellulose) was added in small amounts to a solution that contained alcohol (SOLMIX; registered trademark) and 2-(2-n-butoxyethoxy)ethyl acetate in the ratio of 3:1, while stirring the solution in order not to form a cluster of the binder. The solution was stirred until the binder was dissolved and the solution became transparent. The solution obtained as described above was poured into a nylon resin pot that previously contained 20% by weight of zirconia powder (e.g., TZ-0 manufactured by Tosoh Corporation) and a nylon resin ball with a diameter of 10 mm, and combined and stirred for 10 days or more using a ball mill.

Deposition 2 of Separator

A hose-like cap was placed on the upper end of the ceramic tube having two layers of alumina film laminated on the inner side surface, and a sealing stopper was placed on the lower end thereof. By using a funnel, the slurry used to deposit the third and fourth layers was injected from the upper end of the ceramic tube covered with the hose-like cap, and the ceramic tube filled fully to the top with the slurry was held for one minute. After the elapse of one minute, the sealing stopper on the lower end was removed to discharge the slurry. Thereafter, the ceramic tube was dried at ambient temperature for 15 hours or more and then at 50° C. for two hours or more. The dried ceramic tube was then fired at 1000° C. for four hours to obtain a ceramic tube having three layers of film (two layers of alumina film and single layer of zirconia film) laminated on the inner side surface.

Next, the ceramic tube was placed upside down, opposite to the way in which the third layer was deposited, and the hose-like tube was placed on the upper end and the sealing stopper was placed on the lower end in the same way. Then, the same slurry as used to deposit the third layer was injected from the upper end of the ceramic tube covered with the hose-like cap, and the ceramic tube filled fully to the top with the slurry was held for one minute. After the elapse of one minute, the sealing stopper on the lower end was removed to discharge the slurry. Thereafter, the ceramic tube was dried at ambient temperature for 15 hours or more and then at 50° C. for two hours or more. The dried ceramic tube was fired at 1000° C. for four hours to obtain a ceramic tube having four layers of film (two layers of alumina film and two layers of zirconia film) laminated on the inner side surface.

Preparation of Slurry for Liquid Repellent Layer

First, undiluted FEP dispersion manufactured by Du Pont-Mitsui Fluorochemicals Co., Ltd. was diluted to 20 wt %, and 2.8% by weight of ALKOX (registered trademark) E-30 serving as a thickener was weighed and added in small amounts to the diluted FEP solution, while stirring the solution in order not to form a cluster of the thickener.

Deposition of Liquid Repellent Layer

The interconnector area of the ceramic tube was covered with a tape so that a portion of the liquid repellent layer that overlapped with the interconnector had a width of 1 mm. The ceramic tube was then immersed in the aforementioned dispersion for one minute, dried at ambient temperature for 30 minutes and then at 60° C. for 15 hours, and fired at 280° C. for 50 minutes to obtain a ceramic tube having a liquid repellent layer.

Sample Evaluation

The gas permeability of the obtained samples was evaluated by an N₂ gas permeability test, and the anti-water pressure characteristics of the samples were evaluated by an anti-water pressure test. The gas permeability of the cylindrical alumina porous ceramic tube was 3015 m³/(m²·h·atm), whereas the gas permeability of the ceramic tube including the buffer layer, the conductive layer, the catalyst layer, the separator, the interconnector, and the liquid repellent layer was 93 m³/(m²·h·atm). The result of the anti-water pressure test in which the inside of the ceramic tube was filled with water and gradually pressurized with an N₂ gas showed that leakage was confirmed at 0.065 MPa.

Battery Evaluation

A Cu coil (negative electrode) having 2 g of electrodeposited Zn was inserted into each obtained positive electrode (air electrode), an electrolyte solution (7 M KOH+0.65 M ZnO) was circulated inside the positive electrode, and battery performance was evaluated at ambient temperature. As a result, the voltage reached 0.70V and the power density was 0.002 W/cm² at a current density of 2.3 mA/cm² during discharge. During charge, the voltage reached 15V at a current density of 25 mA/cm².

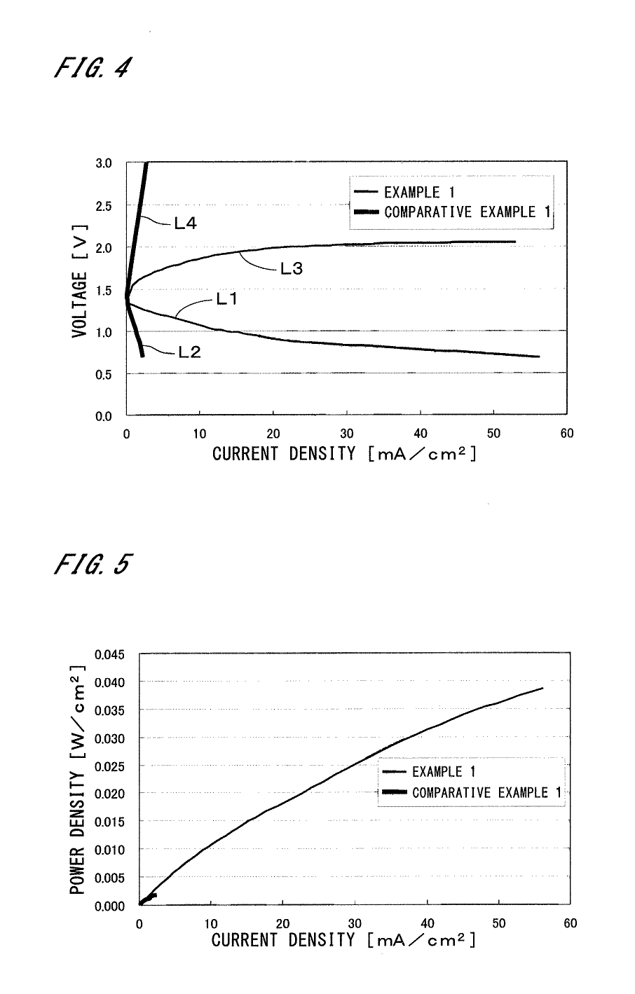

FIG. 4 illustrates the charge and discharge properties of a metal-air battery using the positive electrode according to Example 1 and a metal-air battery using the positive electrode according to Comparative Example 1. FIG. 5 illustrates the power densities of the metal-air battery using the positive electrode according to Example 1 and the metal-air battery using the positive electrode according to Comparative Example 1. As can be seen from FIG. 4, the metal-air battery using the positive electrode according to Example 1, i.e., the positive electrode using the positive electrode main body as a supporter, exhibits a higher discharge voltage (see L1 and L2 in FIG. 4) and a lower charge voltage (see L3 and L4 in FIG. 4) than the metal-air battery using the positive electrode according to Comparative Example 1, i.e., the positive electrode using the separator as a supporter. It can also be seen from FIG. 5 that the metal-air battery using the positive electrode according to Example 1 exhibits a higher power density than the metal-air battery using the positive electrode according to Comparative Example 1. Thus, it can be said that the metal-air battery using the positive electrode according to Example 1 exhibits higher battery performance than the metal-air battery using the positive electrode according to Comparative Example 1. Note that the time required to produce the positive electrode according to Example 1 is approximately two-thirds of the time required to produce the positive electrode according to the comparative example.

### Example 2

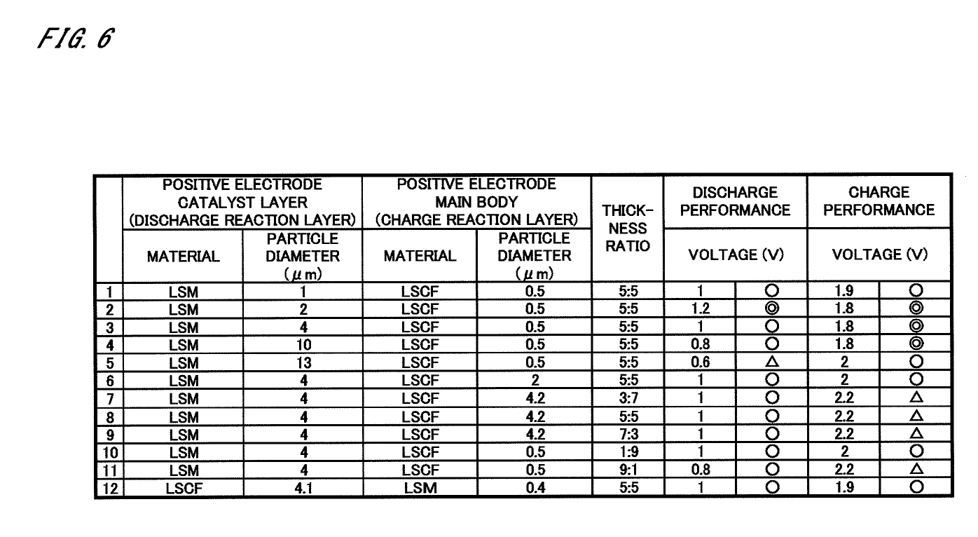

First, LaSrMnO₃ (LSM) powder and LaSrCoFeO₃ (LSCF) powder (both manufactured by KCM Corporation Co., Ltd.) were pulverized into coarse particles by a cutter mill and then into fine particles by a jet mill (manufactured by Nisshin Engineering INC.), and then classified by Turbo Classifier to obtain LSM powder and LSCF powder having various particle diameters. Then, a technique similar to that of Example 1 was used to form a ceramic tube serving as a positive electrode main body with use of a combination of material (catalyst type) and particle diameter (average particle diameter) entered in the “Positive Electrode Main Body (Charge Reaction Layer)” field in FIG. 6, and form a positive electrode catalyst layer on the outer side surface of the ceramic tube with use of a combination of material and particle diameter entered in the “Positive Electrode Catalyst Layer (Discharge Reaction Layer)” field. The “Thickness Ratio” field in FIG. 6 indicates the ratio (T1:T2) between a thickness T1 of the positive electrode catalyst layer and a thickness T2 of the positive electrode main body (ceramic tube).

A Cu coil having 2 g of electrodeposited Zn was inserted as a negative electrode inside the positive electrode samples produced as described above, an electrolyte solution (containing 7 molar (M) KOH and 0.65 M zinc oxide (ZnO)) was circulated inside the samples, and discharge and charge properties of batteries were measured at ambient temperature. In FIG. 6, the leftmost column describes the number of each positive electrode sample, and the “Discharge Performance” and “Charge Performance” fields describe voltages at a power density of 10 mA/cm² in the metal-air batteries using each sample. Additionally, the “Discharge Performance” field is marked with a double circle when the voltage is higher than or equal to 1.2V, marked with a single circle when the voltage is less than 1.2V and higher than or equal to 0.8V, and marked with a triangle when the voltage is less than 0.8V and higher than or equal to 0.6V. The “Charge Performance” field is marked with a double circle when the voltage is less than or equal to 1.8V, marked with a single circle when the voltage is higher than 1.8V and less than or equal to 2.0V, and marked with a triangle when the voltage is higher than 2.0V and less than or equal to 2.2V.

The results of the discharge performance of the first to fifth samples in FIG. 6 show that the discharge performance of the metal-air batteries improve if the average particle diameter of the particles of the positive electrode catalyst layer is larger than or equal to 1 μm and smaller than or equal to 10 μm. From the viewpoint of more reliably preserving the gas diffusion properties of the positive electrode catalyst layer, the average particle diameter of the particles of the positive electrode catalyst layer is preferably larger than or equal to 2 μm. On the other hand, the discharge performance degrades as the effective reaction area decreases in the positive electrode catalyst layer serving as the discharge reaction layer. Thus, from the viewpoint of ensuring higher discharge performance, the average particle diameter of the particles of the positive electrode catalyst layer is preferably smaller than or equal to 6 μm in order to secure a certain amount of effective reaction area.

The positive electrode main body needs pores for holding the electrolyte solution and preferably has an average particle diameter of particles larger than or equal to 0.1 μm and more preferably larger than or equal to 0.2 μm, from the viewpoint of securing pores in a certain range of sizes. It can also be said from the results of the charge performance of the third, sixth, and eighth samples that the charge performance of the metal-air batteries improves if the average particle diameter of the particles of the positive electrode main body is smaller than or equal to 2 μm. Since the charge performance improves as the average particle diameter of particles decreases, i.e., the effective reaction area increases, it can be said from the above results that the average particle diameter of particles is more preferably smaller than or equal to 0.8 μm.

Considering the value (D1/D2) for the ratio between the average particle diameter D1 of the particles of the positive electrode catalyst layer and the average particle diameter D2 of the particles of the positive electrode main body, a preferable range of (D1/D2) is from 1 to 100 and more preferably from 2 to 20. The results of the charge and discharge performance of the third, tenth, and eleventh samples show that the charge and discharge performance for the case where the thickness ratio is 1:9 or 9:1 is lower than the charge and discharge performance for the case where the thickness ratio is 5:5. On the other hand, the results of the charge and discharge performance of the seventh to ninth samples show that a certain degree of charge and discharge performance can be preserved if the thickness ratio is 3:7, 5:5, or 7:3. Accordingly, the positive electrode catalyst layer preferably has a thickness that is greater than or equal to 0.4 times the thickness of the positive electrode main body (which corresponds to the thickness ratio of 3:7) and less than or equal to 2.3 times the thickness of the positive electrode main body (which corresponds to the thickness ratio of 7:3). In this case, a certain degree of both discharge and charge performance of the metal-air batteries can be ensured.

The metal-air battery 1 described above may be modified in various ways.

In the metal-air battery 1, the negative electrode 3 may be provided around the tubular positive electrode 2. That is, the negative electrode 3 may oppose either the inner or outer side surface of the positive electrode 2. In the metal-air battery 1 in which the negative electrode 3 opposes the outer side surface of the positive electrode 2, the separator 41 is provided on the outer side surface of the positive electrode main body 21.

Depending on the design of the metal-air battery 1, for example, the separator 41 may be prepared as a tubular independent member and inserted inside the positive electrode main body 21 having an outer side surface on which the positive electrode catalyst layer 22 is formed. Depending on the required battery performance of the metal-air battery 1, only the separator 41 may be formed on the inner side surface of the positive electrode main body 21, and the positive electrode catalyst layer 22 may be omitted. In the metal-air battery 1, a porous film made of ceramic is formed on either the inner or outer side surface of the positive electrode main body 21 serving as a tubular supporter, i.e., the positive electrode main body 21 is provided as a tubular member that can support a porous film made of ceramic on the inner or outer side surface. This configuration makes it possible to easily increase the thickness of the positive electrode 2 and to thereby reduce the electrical resistance of the positive electrode 2 and improve battery performance. If the generation of dendrites causes little problems, the separator 41 may be omitted.

The configurations of the above-described preferred embodiments and variations may be appropriately combined as long as there are no mutual inconsistencies.

While the invention has been shown and described in detail, the foregoing description is in all aspects illustrative and not restrictive. It is therefore to be understood that numerous modifications and variations can be devised without departing from the scope of the invention.

### REFERENCE SIGNS LIST

1 Metal-air battery
2 Positive electrode
3 Negative electrode
4 Electrolyte layer
21 Positive electrode main body
22 Positive electrode catalyst layer
41 Separator

1. A metal-air battery comprising:
a tubular positive electrode;
a negative electrode opposing an inner or outer side surface of said positive electrode; and
an electrolyte layer disposed between said negative electrode and said positive electrode,
wherein said positive electrode includes a porous positive electrode main body that is made of conductive ceramic and serves as a tubular supporter, and
a porous film made of ceramic is formed on an inner or outer side surface of said positive electrode main body.

2. The metal-air battery according to claim 1, wherein
said porous film serves as a separator that is made of said ceramic having insulating properties and formed on a surface of said positive electrode main body on a side of said negative electrode.

3. The metal-air battery according to claim 2, wherein
said positive electrode main body has a thickness greater than a thickness of said separator.

4. The metal-air battery according to claim 1, wherein
said porous film serves as a positive electrode catalyst layer that is formed on a surface of said positive electrode main body on a side opposite to said negative electrode.

5. The metal-air battery according to claim 2, wherein
another porous film that is made of ceramic and serves as a positive electrode catalyst layer is formed on a surface of said positive electrode main body on a side opposite to said negative electrode, and
said porous film is formed on said inner side surface of said positive electrode main body, and said another porous film is formed on said outer side surface of said positive electrode main body.

6. The metal-air battery according to claim 4, wherein
said ceramic of said positive electrode catalyst layer has a crystal structure that is identical to a crystal structure of said conductive ceramic of said positive electrode main body.

7. The metal-air battery according to claim 4, wherein
said ceramic of said positive electrode catalyst layer is superior in oxygen reduction reaction to said conductive ceramic of said positive electrode main body, and
said conductive ceramic of said positive electrode main body is superior in oxygen generation reaction to said ceramic of said positive electrode catalyst layer.

8-10. (canceled)

11. The metal-air battery according to claim 3, wherein
another porous film that is made of ceramic and serves as a positive electrode catalyst layer is formed on a surface of said positive electrode main body on a side opposite to said negative electrode, and
said porous film is formed on said inner side surface of said positive electrode main body, and said another porous film is formed on said outer side surface of said positive electrode main body.

12. The metal-air battery according to claim 5, wherein
said ceramic of said positive electrode catalyst layer has a crystal structure that is identical to a crystal structure of said conductive ceramic of said positive electrode main body.

13. The metal-air battery according to claim 11, wherein
said ceramic of said positive electrode catalyst layer has a crystal structure that is identical to a crystal structure of said conductive ceramic of said positive electrode main body.

14. The metal-air battery according to claim 5, wherein
said ceramic of said positive electrode catalyst layer is superior in oxygen reduction reaction to said conductive ceramic of said positive electrode main body, and
said conductive ceramic of said positive electrode main body is superior in oxygen generation reaction to said ceramic of said positive electrode catalyst layer.

15. The metal-air battery according to claim 6, wherein
said ceramic of said positive electrode catalyst layer is superior in oxygen reduction reaction to said conductive ceramic of said positive electrode main body, and
said conductive ceramic of said positive electrode main body is superior in oxygen generation reaction to said ceramic of said positive electrode catalyst layer.

16. The metal-air battery according to claim 11, wherein
said ceramic of said positive electrode catalyst layer is superior in oxygen reduction reaction to said conductive ceramic of said positive electrode main body, and
said conductive ceramic of said positive electrode main body is superior in oxygen generation reaction to said ceramic of said positive electrode catalyst layer.

17. The metal-air battery according to claim 12, wherein
said ceramic of said positive electrode catalyst layer is superior in oxygen reduction reaction to said conductive ceramic of said positive electrode main body, and
said conductive ceramic of said positive electrode main body is superior in oxygen generation reaction to said ceramic of said positive electrode catalyst layer.

18. The metal-air battery according to claim 13, wherein
said ceramic of said positive electrode catalyst layer is superior in oxygen reduction reaction to said conductive ceramic of said positive electrode main body, and
said conductive ceramic of said positive electrode main body is superior in oxygen generation reaction to said ceramic of said positive electrode catalyst layer.
